(19) United States
(12) Patent Application Publication
(10) Pub. No.: US 2009/0212233 A1
(43) Pub. Date: Aug. 27, 2009

(54) MALDI CHIP HOLDER

(75) Inventors: Karsten Reihs, Koln (DE); Udo Adels, Düren (DE); Guido Steffen, Schleiden (DE)

Correspondence Address: DOBRUSIN & THENNISCH PC, 29 W LAWRENCE ST, SUITE 210, PONTIAC, MI, 48342, US

(73) Assignee: QIAGEN GMBH, Hilden (DE)

(21) Appl. No.: 11/814,837

(22) PCT Filed: Jan. 31, 2006
(86) PCT No.: PCT/EP06/50573

§ 371 Date: Sep. 23, 2008

(30) Foreign Application Priority Data
Feb. 1, 2005 (DE) 20 2005 001 641.1

(51) Int. Cl. G21K 5/08; H01J 29/02

(52) U.S. Cl. 250/440.11; 250/522.1

(57) ABSTRACT

The invention relates to a holder for a MALDI chip, having a broken corner contour, comprising a first and second respectively accessible bearing surface and a moveable fixing means which interacts with the broken corner contour and which pre-tenses the MALDI chip against the bearing surfaces. The invention also relates to a MALDI chip and a system consisting of the holder and the MALDI chip.

The present invention relates to a holder for a MALDI chip, having a broken corner contour, comprising a first and a second respectively chamfered abutting surface aid a movable fixing means, which interacts with the broken corner contour and thereby prestresses the MALDI chip against the abutting surfaces. The present invention furthermore relates to a MALDI chip and a system comprising the holder and the MALDI chip.

Mass spectrometry has increasingly gained acceptance for the analysis of samples for example in active compound chemistry or in biological research and production. Mass spectrometry with ionization by matrix assisted laser desorption and ionization (MALDI) is preferably used for the analysis of biomolecules situated in the samples.

In the MALDI method, in particular biomolecules and/or biological material are/is metered, for example pipetted, in the form of a liquid drop onto a so-called MALDI matrix point, and dried. The crystals that form in the process are examined for example using a MALDI-TOF mass spectrometer in linear or reflector operation. Details about this method can be gathered from Nordhoff et al. “MALDI-MS as a new method for the analysis of nucleic acid (DNA and RNA) with molecular masses up to 150, 000 Dalton”, Application of modern mass spectrometric methods to plant science research, Oxford University Press, (1996), pages 86-101, which is hereby incorporated as reference and is thus deemed to be part of the disclosure.

In the MALDI method, in some instances more than 200 MALDI matrix points are applied to a sample carrier—referred to hereinafter as MALDI chip—which matrix points then have to be analyzed. The person skilled in the art understands that both the application of the samples and the later analysis, on account of the multiplicity of MALDI matrix points arranged on a comparatively small space, require a very high precision, inter alia a very precise positioning of the MALDI chip.

Therefore, the object of the present innovation was to provide a holder on which a MALDI chip can be positioned very exactly and reproducibly.

The object is achieved by means of a holder in accordance with claim 1. Preferred embodiments of the holder according to the invention are claimed in claims 2 to 11.

It was extremely astonishing and unexpected to the person skilled in the art that a MALDI chip can be positioned very exactly and reproducibly by means of the holder according to the invention, such that the metering of the substances to be analyzed and/or the subsequent analyses can be carried out very exactly. The holder according to the invention is simple and cost-effective to produce and to use. The exact position of the MALDI chips is not impaired even by deposits on the holder.

The holder is suitable for the mounting of MALDI chips with a broken, i.e. flattened corner contour.

According to the invention, the holder has a first and a second abutting surface, which are preferably arranged at right angles to one another and on which the MALDI chip abuts. Furthermore, the holder according to the invention has a fixing means by which the MALDI chip can be fixed in abutment with the abutting surfaces. According to the invention, the MALDI chip is prestressed against the abutting surfaces by the fixing means. This has the advantage that even in the event of mechanical influences such as, for example, vibrations or temperature influences, the MALDI chip is permanently in abutment with the first and the second abutting surface, such that its position in a plane is a least unambiguously defined. Furthermore, according to the invention the fixing means interacts with the broken corner contour.

The holder preferably has a bearing surface, on which the MALDI chip bears.

The abutting surfaces of the holder according to the invention are preferably chamfered in such a way that the MALDI chip, particularly if it is under prestress, is prestressed against the bearing. This embodiment of the present invention has the advantage that the spatial position of the MALDI chip on the holder according to the invention is unambiguously determined and the MALDI chip is always held in an unambiguous position.

In one preferred embodiment of the holder according to the invention, the fixing means also has an abutting surface that interacts with the MALDI chip and is preferably complementary to a corner contour of the MALDI chip. Preferably, said abutting surface is also chamfered, such that the MALDI chip is also pressed against the bearing surface of the holder by said abutting surface.

Any fixing means that is familiar to the person skilled in the art is suitable as fixing means. However, the fixing means is preferably a slide. Said slide preferably has a spring that prestresses it in the direction of the abutting surfaces.

Preferably, at least one abutting surface of the holder is at least partly coated with a material having a very good electrical conductivity, which material particularly preferably does not corrode. By way of example, the material is gold.

In a further preferred embodiment of the present invention, the bearing surface has a cutout, in particular a hole. The removal of the MALDI chip after analysis has been carried out is facilitated through said hole.

One or a plurality of spring means is or are furthermore preferably arranged on the opposite side of the holder to the bearing surface, which spring means enable the holder to be prestressed with respect to the analysis device.

Moreover, the holder preferably has a lever that can be transferred reversibly from a locking to an unlocking position. Preferably, the lever is provided in latching fashion in both positions. In the locked position, the lever preferably conceals the cutout in the bearing surface and furthermore preferably blocks the fixing means. Both measures prevent the MALDI chip from being inadvertently removed from the holder. In the unlocked position, the opening in the bearing surface is freely accessible and the fixing means is unlocked, such that the MALDI chip can be released from the holder.

A further subject matter of the present invention is a MALDI chip having a gold-plated edge region.

Preferably, the gold-plated edge region and the analysis region are connected to one another by a conductor track.

Yet another subject matter of the present invention is a system comprising the holder according to the invention and the MALDI chip according to the invention.

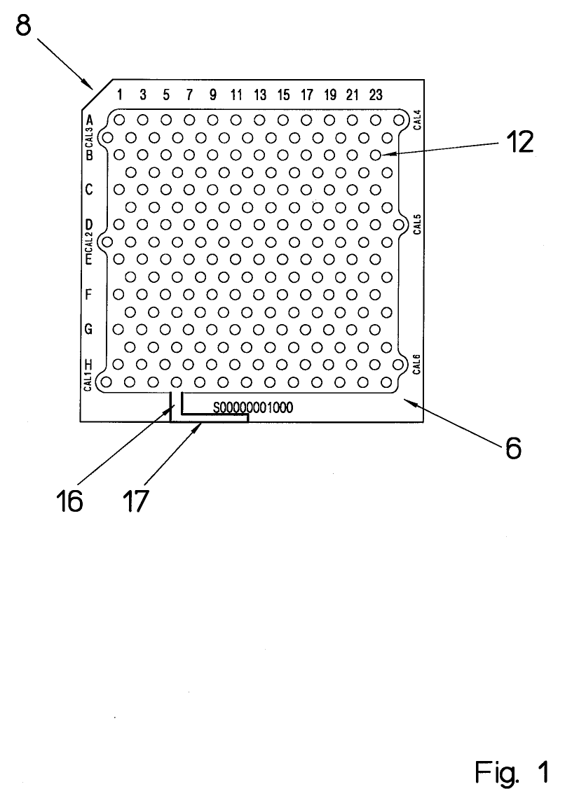

The innovation is explained below with reference to FIGS. 1 to 6. These explanations are merely by way of example and do not restrict the general concept of the innovation.

FIG. 1 schematically shows a MALDI chip.

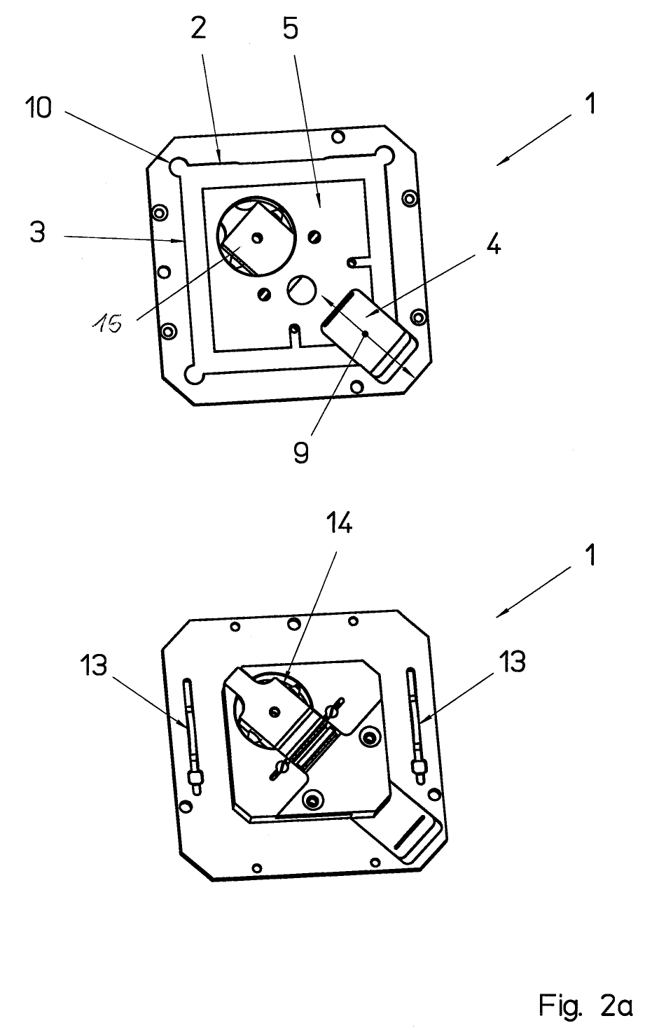

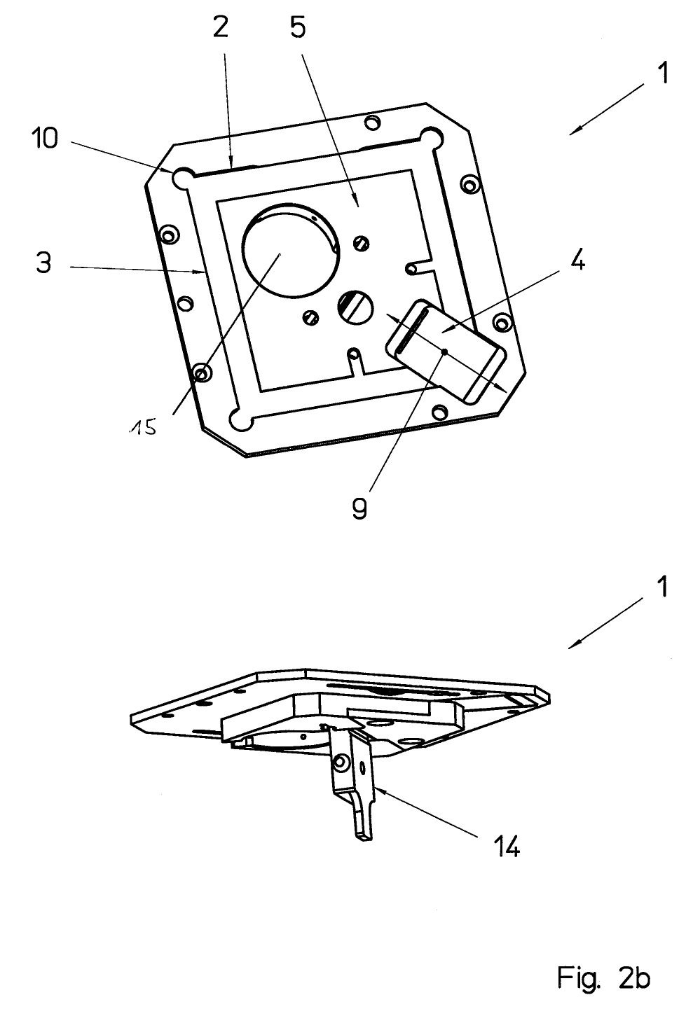

FIGS. 2a and 2b in each case show the holder according to the invention in two states.

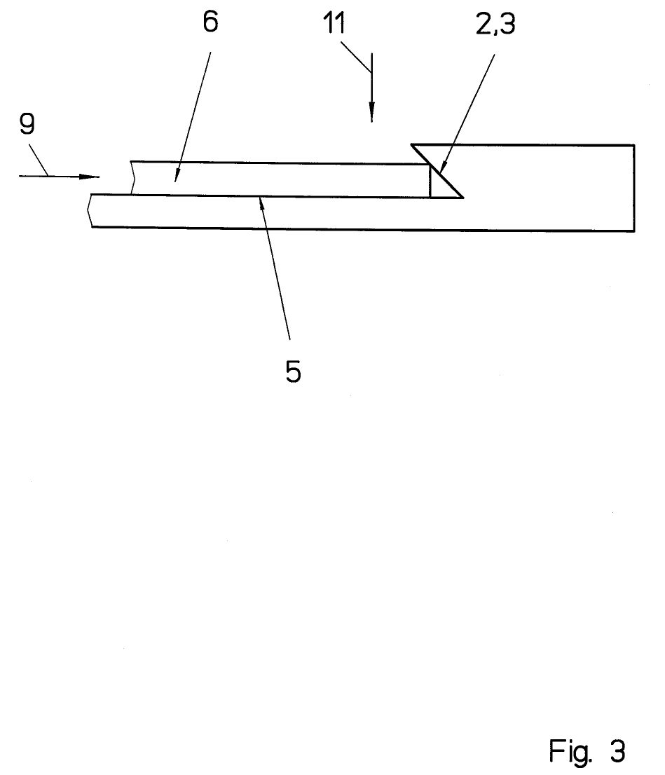

FIG. 3 shows a section through the holder according to the invention.

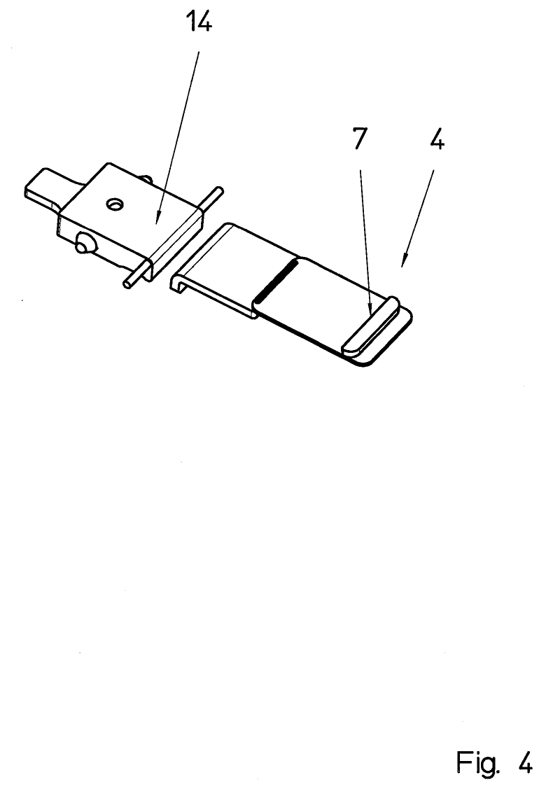

FIG. 4 shows the slide of the holder according to the invention in interaction with the lever.

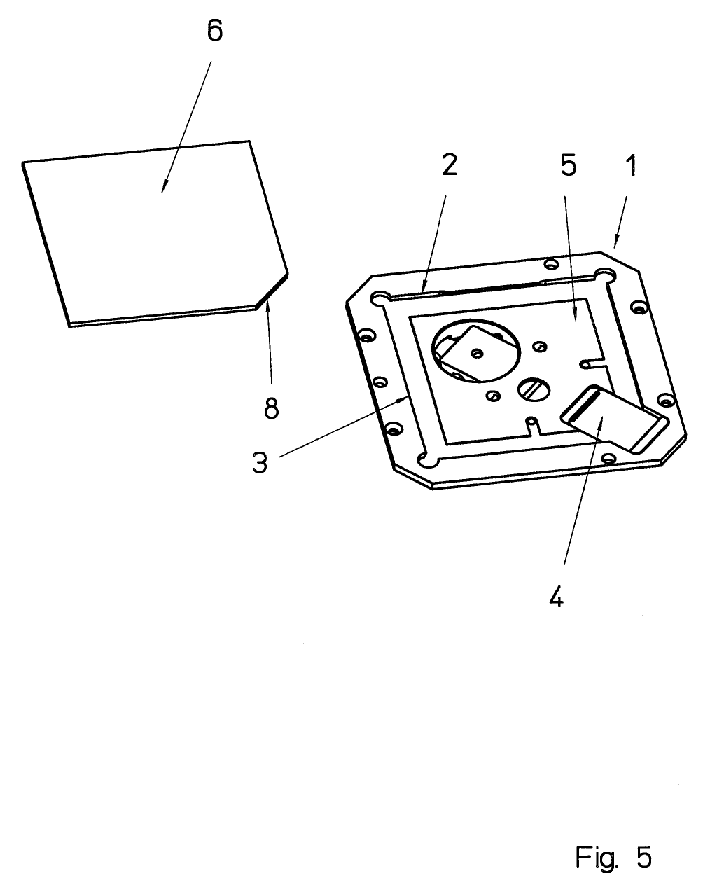

FIG. 5 shows the holder according to the invention with a MALDI chip.

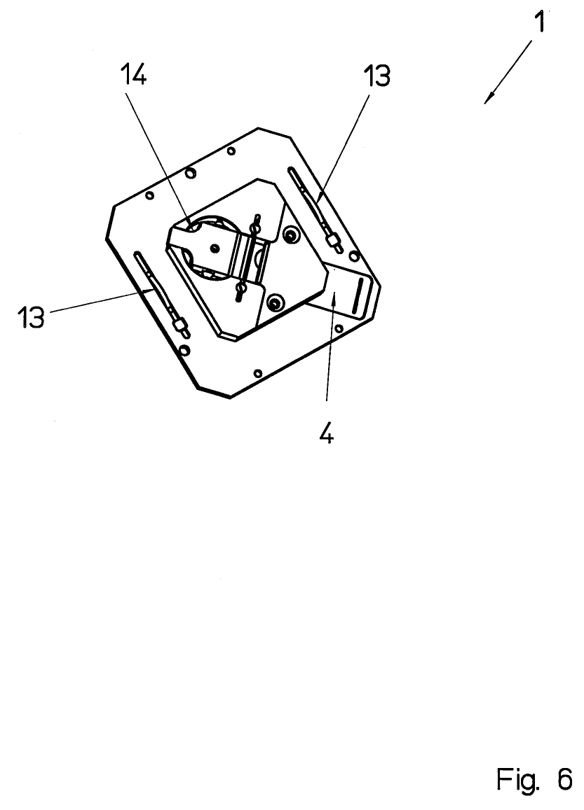

FIG. 6 shows the underside of the holder.

FIG. 1 shows a MALDI chip 6 having a multiplicity of points 12 onto which a MALDI matrix can be metered. The MALDI chip has a flattened corner contour 8 at its top left corner, the person skilled in the art recognizing that the corner contour can also be configured differently.

FIG. 2a shows the holder 1 according to the invention in the state fixing the MALDI chip, the MALDI chip having been omitted for reasons of clarity. The holder 1 has a first and a second abutting surface 2, 3, on which the MALDI chip 6 (not illustrated in this figure) abuts. A cutout 10 is arranged between the abutting surfaces 2, 3, which cutout is required for processing the abutting surfaces, 2, 3, on the one hand, but also prevents the MALDI chip from abutting only at its corner point. Furthermore, the mounting according to the invention has a bearing surface 5, on which the MALDI chip 6 bears. The MALDI chip is pressed against the abutting surfaces 2, 3 by means of the slide 4, which can be moved in accordance with the directions identified by the double-headed arrow 9 and which is prestressed by a spring (not illustrated) in the direction of the abutting surfaces 2, 3. As a result of the MALDI chip abutting on the abutting surfaces 2, 3, its position in the paper plane is unambiguously determined. The upper illustration shows a slide from above, that is to say from the side on which the MALDI chip bears. The slide 4 is situated in its front position, i.e. in a position fixing the MALDI chip. The cutout 15 in the bearing surface 5 is clearly discernible, which is covered from behind by the lever 14 in the state fixing the MALDI chip. The lower illustration shows the holder 1 from below. The lever 14 abuts on the holder and conceals the cutout 15. In this position, the lever on the one hand prevents an object from being inserted through the cutout 15 which presses the MALDI chip from its fixing. Furthermore, the slide 4 is blocked by the lever 14, such that it cannot be transferred into a retracted position.

FIG. 2b shows the holder in accordance with FIG. 2a in the rear unlocking position of the slide, in which position the MALDI chip can be removed or a new MALDI chip can be inserted into the holder. In this position, the lever 14 is arranged essentially perpendicular to the holder and thereby frees the opening 15. The locking of the slide 4 is furthermore canceled by the lever.

FIG. 3 shows the MALDI chip 6 in its exactly fixed position. This illustration reveals that the abutting surfaces 2, 3 are chamfered, such that the spring force of the fixing means 4, on the abutting surfaces 2, 3, also induces a downwardly directed movement which is symbolized by the arrow 11 and which holds the MALDI chip 6 permanently in abutment with the bearing surface 5, thereby ensuring that the MALDI chip 6 is also spatially positioned unambiguously on the holder.

FIG. 4 shows the slide of the holder according to the invention, having an abutting surface 7 corresponding to the corner contour 8 of the MALDI chip 6. The abutting surface 7 is also chamfered, such that the MALDI chip is also pressed against the bearing surface by this surface. The lever 14, which here is illustrated in the locking position, does not touch the slide 4 in this position. In this position, the slide 4 has contact with the corner contour 8 of the MALDI chip 6 and presses the latter onto the abutting surfaces 3.

FIG. 5 shows how a MALDI chip is inserted into the holder according to the invention. For this purpose, first of all the slide 4 is moved downward toward the right and locked in this position. The MALDI chip is then inserted into the holder in such a way that the flattened corner contour 8 points in the direction of the slide. As soon as the MALDI chip 6 lies in the holder, the slide is shifted and, on account of the force of the spring present (not illustrated), presses the MALDI chip into the top left corner in such a way that it abuts on the abutting surfaces 2, 3.

FIG. 6 shows the underside of the holder, having leaf springs 13 that prestress the holder against the analysis device and ensure good electrical contact with the analysis device.

### REFERENCE SYMBOLS

1 Holder
2, 3 Abutting surfaces
4 Fixing means
5 Bearing surface
6 MALDI chip
7 Abutting surface
8 Corner contour
9 Double-headed arrow, movement of the slide
10 Cutout
11 Arrow, direction of the press-on force in the direction of the bearing surface
12 Points onto which the MALDI matrix can be metered
13 Spring means, leaf spring
14 Lever (latchable in the closed position and in the open position)
15 Cutout, hole
16 Conductor track
17 Gold-plated edge region

1. A holder for a MALDI chip, the MALDI chip having a broken corner contour, comprising: a first and a second respectively chamfered abutting surface and a movable fixing means, which interacts with the broken corner contour and thereby prestresses the MALDI chip against the abutting surfaces.

2. The holder according to claim 1 is characterized in that it has a bearing surface.

3. The holder as claimed in claim 2, characterized in that the first and second abutting surfaces are chamfered in such a way that the MALDI chip is prestressed against the bearing surface.

4. The holder as claimed in claim 3, characterized in that the fixing means has a third abutting surface, the contour of which is complementary to the broken corner contour of the MALDI chip.

5. The holder as claimed in claim 4, characterized in that the third abutting surface is chamfered in such a way that the MALDI chip bears permanently on the bearing surface (5).

6. The holder as claimed in claim 1, characterized in that the fixing means is a slide.

7. The holder as claimed in claim 6, characterized in that the slide has a spring that prestresses it in the direction of the first and second abutting surfaces.

8. The holder as claimed in claim 1, characterized in that at least one of the abutting surfaces is at least partly coated with a material having very good electrical conductivity.

9. The holder as claimed in claim 2, characterized in that it has a hole in the bearing surface.

10. The holder as claimed in claim 2, characterized in that spring means are arranged on the opposite side of the holder to the bearing surface.

11. The holder as claimed in claim 1, characterized in that the holder has a lever that can be transferred reversibly from a locking to an unlocking position.

12. A MALDI chip having a gold-plated edge region.

13. The MALDI chip as claimed in claim 12, wherein the gold-plated edge region and an analysis region of the MALDI chip are connected to one another by a conductor track (16).

14. The MALDI chip as claimed in claim 12, having a broken corner contour.

15. A MALDI chip holding system comprising:
i. a MALDI chip having a broken corner contour, and
ii. a holder for the MALDI chip, including a first and a second respectively chamfered abutting surface and a movable fixing means, which interacts with the broken corner contour and thereby prestresses the MALDI chip against the abutting surfaces.

16. The MALDI chip holding system as claimed in claim 15, wherein the MALDI chip has a gold-plated edge region.

17. The MALDI chip holding system as claimed in claim 16, wherein the gold-plated edge region and an analysis region of the MALDI chip are connected to one another by a conductor track.

18. The MALDI chip holding system as claimed in claim 17, wherein the holder has a bearing surface on which the MALDI chip is seated, and further wherein the first and second abutting surfaces are arranged at approximately right angles to one another and chamfered in such a way that the MALDI chip is prestressed against the bearing surface.

19. The MALDI chip holding system as claimed in claim 18 wherein the fixing means comprises a third abutting surface that interacts with the MALDI chip, is complementary to a corner contour of the MALDI chip, and is chamfered such that the MALDI chip is pressed against the bearing surface.

20. The MALDI chip holding system as claimed in claim 19 wherein the fixing means includes a slide having a spring that prestresses in the direction of the first and second abutting surfaces, further wherein at least one of the abutting surfaces is at least partly coated with gold, further wherein the holder comprises a cutout in the bearing surface facilitating the removal of the MALDI chip after analysis.
